(19) United States
(12) Patent Application Publication
(10) Pub. No.: US 2005/0247382 A1
(43) Pub. Date: Nov. 10, 2005

(54) Process for producing a new high-strength dual-phase steel product from lightly alloyed steel

(76) Inventor: Pertti J. Sippola, Espoo (FI)

Correspondence Address: Robert G. Lev, 4766 Michigan Boulevard, Youngstown, OH, 44505, US

(21) Appl. No.: 10/840,407

(22) Filed: May 6, 2004

(51) Int. Cl. B32B 15/18

(52) U.S. Cl. 148/533; 428/659; 427/433

(57) ABSTRACT

A high strength, dual-phase steel is produced using rapid cooling/quenching techniques. Such techniques limit formation of upper bainite and eliminate pearlite while providing the steel with a high-quality galvanized coating.

### FIELD OF THE INVENTION

The present invention relates to a system and method for producing a new steel product. In particular, the new steel product is a dual-phase steel having uniform ductility, increased strength and excellent welding characteristics.

### BACKGROUND ART

In recent years there has been an increasing demand from the automobile industry for hot-dip, zinc-coated, dual-phase steels to improve crash resistance in accordance with the government standards. These are referred to in the attached S.A.E Technical paper incorporated by reference in this application. This publication, entitled ULSAB-Advanced Vehicle Concepts-Materials #2002-01-0044 (Appendix II) was originally published in March of 2002, and proposes at least one process and at least one resulting dual-phase steel product suitable for new government automotive standards. Some advantages of the resulting product are briefly discussed in the subject S.A.E. publication, and include lighter weight, relatively high ductility, and high strength.

While the steel product produced by the dual-phased process discussed in the subject SAE Technical paper is a marked improvement over materials previously used in the automotive industry, there are still certain limitations. For example, the current hot-dip, zinc-coated, dual-phase steels are produced from a steel substrate having highly alloyed chemistries, including high levels of chromium (Cr) and molybdenum (Mo). It is well known that Mo is the most expensive alloying element used in the steel industry. This is a substantial drawback, especially when taken in conjunction with the high expense of using Cr.

Consequently, it has been a solution of the conventional art to replace Mo with boron and titanium. This development was disclosed in published Patent Document No. WO 01/09396A1, published Feb. 8, 2001, and incorporated herein by reference. However, there are additional concerns regarding the resulting product. In particular, the resulting steel product will serve as a substrate for further finishing and incorporation into an overall manufactured product. To do this, spot welding is usually involved. Thus, the weldability of the steel substrate and its effect on the life of spot welding electrodes is critical. These characteristics result in another major drawback for the otherwise well-developed conventional art described in the subject International Patent.

For better understanding of these limitations, a brief discussion is provided regarding welding characteristics, which constitute a key factor in the evaluation of any steel that is to be used in products manufactured by welding. The weldability of the dual-phase steel substrate discussed in the subject publications will follow the well-known formula:
Pcm=% C+% Si/30+%(Mn+Cu+Cr)/20+% Mo/15+% V/10+5B

The value of Pcm should be less than 0.20% to still achieve the adequate and reliable welding characteristics necessary to be useful in manufacturing steel products. In this respect, the effects on spot welding electrodes which are used on the steel product become crucial in overall manufacturing considerations. The life of spot welding electrodes is dependant upon the aluminum content in the zinc coating usually applied to the steel.

One drawback of using conventional dual-phase systems is that very highly alloyed steel substrates are required. The commercial availability of high-alloyed steel substrate is limited because the steel companies who produce these grades only for their own uses. Also, each existing hot-dip galvanizing line needs a very special alloying chemistry for each strip thickness/gage in order to produce the dual-phase structure. Consequently, each thickness of steel strip used recreates a wide range of differences in manufacturing parameters. This is both awkward and very expensive.

Currently, the present technology is well configured to produce a weldable, hot-dip, zinc-coated, dual-phase steel for a 1 mm gage strip. However, thicker strips become problematical. For example, even with an increase to a 1.6 mm strip, the line speed decreases, causing longer holding times at 460° C. (zinc bath) temperatures. Consequently, far greater alloy percentages are required, thus causing weldability problems onto resulting steel substrate. Also, the P_{cm} value will exceed the maximum allowable limits.

The slower processing speed, and its resulting higher level of alloy creates another problem. In particular, high alloying of steel substrate will heavily decrease the end-value and ductility, which are major benefits of dual-phase steel over other HSLA grades. Also, the amount of Mn should be limited to 1.8% but preferably to 1.65%. Extensive amounts of Mn are not desirable because a segregation layer of martensite, due to high Mn, is easily formed when trying to eliminate a problematical bainite structure as depicted in FIG. 2. This phenomenon is considered in U.S. Pat. No. 3,951,696, published Apr. 20, 1976, and incorporated herein by reference.

FIG. 2 is a time versus temperature graph depicting the course of dual phase steel formation. The key attribute of dual-phase steel process is the formation of austenite. However, there is also the danger of undesirable pearlite formation, as well as bainite formation, before the desirable formation of martensite. The formation of pearlite can be avoided through the use of certain alloying materials (Mn,Cr,Si,Mo). Even with the avoidance of pearlite formation, bainite formation is still problematical. This is particularly true for the lower half of the bainite area (as depicted in FIG. 2), where the curve indicated a relatively long time span to form the product. The problems inherent to substantial bainite formation are well documented in the conventional art.

One solution to the problem discussed in U.S. Pat. No. 3,951,696 is the use of silicon (Si) as one of the alloying materials. It is known that Si accelerates formation of polygonal ferrite, and is effective to eliminate the aforementioned bainite structure. Si also increased the activity of carbon in ferrite, and hence promotes a more ductile ferrite product. This will also produce more martensite, and less bainite structure. This will increase the strength of the dual-phase steel. Si is a particularly useful element in dual-phase steel in that it optimizes the strength-ductility balance. However, other concerns can arise. For example, surface-critical products may need to be produced with smaller amounts of Si, or without Si at all.

This problem is addressed in U.S. Pat. No. 4,361,448, issued Nov. 30, 1982, and incorporated herein by reference. The system of this patent produces a galvanized product from commercially available steel, a plain Mn-Si steel substrate. Also, strips of 1 mm to 2 mm in thickness were produced using virtually one steel chemistry. However, there is a substantial drawback. Unfortunately, the subject technique of this patent used a 5% aluminum alloying in the zinc bath. As a result, the aluminum content of the zinc coating was far too high to be practically usable for spot welding.

Accordingly, there is still a need for high strength dual-phase steel product that can be made with high percentages of Si and/or Mn but still suitable for spot welding by virtue of low percentages of aluminum in the galvanized coating. Such a product would preferably be produced in a high-speed process, and would be less expensive than conventional methods. Further, the end product would still optimize the strength-ductility balance of inexpensive, low alloy steel.

### SUMMARY OF THE INVENTION

Accordingly it is the first object of the present invention to overcome the drawbacks of the conventional art, and to provide additional benefits.

Another object of the present invention is to provide a high-strength, dual-phase steel alloyed product from inexpensive commercially available plain Mn—Si steel chemistry.

It is a further object of the present invention to provide a high-strength, dual-phase steel product in which the original steel substrate is alloyed, having Mn less than 1.65% and Si less than 0.5%, where no other alloying elements are required, or found except as impurities.

It is an additional object of the present invention to provide a low-alloyed, high-strength, dual-phase steel in which a Si—Mn balance can be adjusted so that the level of Si is decreased to maintain desired surface characteristics.

It is still a further object of the present invention to provide a system for making a dual-phased steel product from virtually the same steel chemistry for strip thickness ranging from 1 mm to 2 mm.

It is still a further object of the present invention is to provide a high-strength, dual-phase steel product having a hot-dip zinc-coating with 70 g/m² coating weight on one side, wherein the coating aluminum is less than 0.4%, and preferably less than 0.3%.

It is still a further object of the present invention to produce a high-strength, dual-phase product wherein Si can be deleted and Mn can be increased.

It is yet a further object of the present invention to provide a galvanized high-strength, dual-phase steel strip that facilitates spot welding by minimizing aluminum content in the galvanized coating.

It is yet an additional object of the present invention to provide a high-strength, dual-phase product using a high speed cooling and galvanizing process, which is faster than conventional processes.

It is still a further object of the present invention to provide a high-strength, dual-phase steel product that eliminates the need for high cost alloying elements such as Mo and Cr.

It is again an additional object of the present invention to provide a high-strength, dual-phase steel process that eliminates the transition to pearlite, and minimizes the transition to upper bainite

It is yet another object of the present invention to provide a high-strength, dual-phase steel product which provides more uniform ductility than conventional products, and avoids local strength variations.

It is yet another object of the present invention to provide a high-strength, dual-phase steel product having an n-value which is approximately 1%-10% superior to conventional dual-phase steel products.

It is still an additional object of the present invention to provide a high-strength, dual-phase steel product in which the content of Si is easily adjusted, and can be provided with a higher percentage of Si than is used in conventional steel products without coating defects.

It is still another object of the present invention to provide a high-strength, dual-phase steel product having greater uniformity of Al in the coating, and minimum Fe—Zn dross concentrations which occur in conventional processes.

It again a further object of the present invention to provide a high-strength, dual-phase steel product in a process that enables more uniform hardening across the strip width, and virtual elimination of surface defects of the coating.

It is still additional object of the present invention to provide a high-strength, dual-phase galvanized steel product at cost savings of approximately 15% over conventional techniques for surface critical applications currently produced only by continuous annealing plus electrozinc galvanizing.

It is yet another object of the present invention to provide a high-strength, dual-phase steel product which minimizes aluminum in its galvanized coating, thereby facilitating spot welding, and longer life for welding electrodes.

It is yet a further object of the present invention to provide a high-strength, dual-phase steel product using a process that uses the same steel chemistry for strips having thickness of 1 mm-2 mm.

It is still an additional object of the present invention to provide a high-strength, dual-phase steel product using inexpensive commercially available plain low alloy steel substrates, having only Mn and Si as alloying agents.

It is again another object of the present invention to provide a process for making a high-strength, dual-phase steel product where thicker steel strips do not have to be more heavily alloyed so that the same steel chemistry works for 1 mm and 2 mm strips.

It is again a further object of the invention to provide a process for producing high-steel, dual-phase steel products which is faster cooling and more efficient than conventional processes.

It is yet a further object of the present invention is to provide a process for producing high-strength, dual-phase steel products in which the process avoids the pearlite phase without expensive Cr or Mo alloying agents.

It is yet an additional object of the present invention to produce a high-strength, dual-phase steel product with uniform ductility, and the avoidance of local strength variations so that the overall product has a higher strength consistency than conventional dual-phase steel products.

It is again a further object of the present invention to produce a high-strength, dual-phase steel product using conventional furnace annealing and galvanizing arrangements, having adaptations for optimizing efficiency.

It still another object of the present invention to provide a process for producing high-strength, dual-phase steel products in which the upper bainite phase is minimized, while using only Mn and Si alloys.

It is again a further object of the present invention to provide a process for producing high-strength, dual-phase steel, in which the process has a cooling time from 760° C. to below 450° C. in less than 40 seconds, and preferably less than 25 seconds for steel strips having a thickness from 1 mm to 2 mm.

It is still another object of the present invention to provide a process for making high-strength, dual-phase steel in which some retained austenite will be present, along with ferrite and martensite and some lower bainite.

It is yet an additional object of the present invention to provide a process for making high-strength, dual-phase steel, where processing time is sufficiently short so that all of the metallurgical requirements for dual-phase steel are fully met, for any variation in the manufacture of dual-phase steel.

These and other goals and objects of the present invention are achieved by a high strength dual-phase steel alloy having ferrite, martensite retained austenite no pearlite, and minimal retained upper bainite, with a low-weight aluminum galvanized coating.

Another aspect of the present invention is achieved by a process for producing dual-phase steel alloy having substantially uniform strength properties. The process includes, rapid cooling to limit upper bainite formation and avoid pearlite formation.

An additional aspect of the present invention is manifested by a dual-phase steel processing system having a portion for rapid quenching to avoid formation of pearlite and minimize upper bainite formation.

### BRIEF DESCRIPTION OF THE DRAWINGS

FIG. 1 is a diagram depicting a steel strip processing installation modified in accordance with the present invention.

FIG. 2 is a graph of temperature versus time for a conventional dual-phase steel process.

FIG. 3 is a graph of temperature versus time for the inventive dual-phase process.

FIG. 4 is a graph of temperature versus time depicting a comparison for two strips processed of the present invention.

### DETAILED DESCRIPTION OF THE PREFERRED EMBODIMENTS

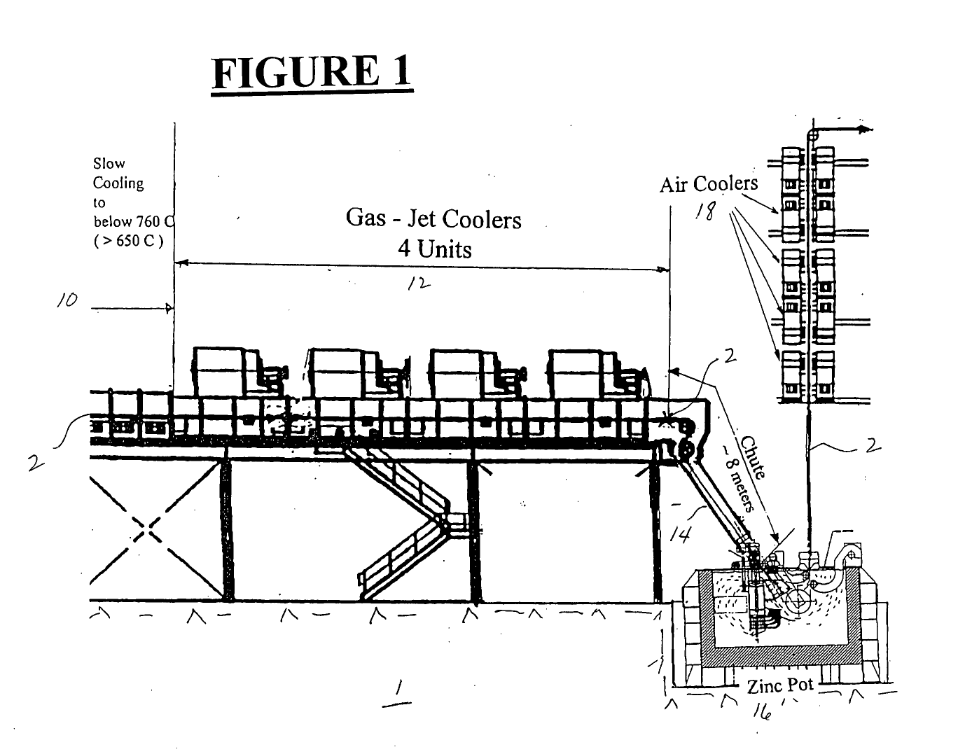

The present invention is practiced using the dual-phase steel processing facility 1 as depicted in FIG. 1. This system accommodates rapid quenching of the steel strip 2 being processed, and is configured to increase the cooling speed and efficiency of the process. In particular, the inventive addition of a galvanizing bath 16 to the dual-phase processing system of FIG. 1 can be the same or similar to the one depicted in U.S. Pat. No. 5,958,518, incorporated herein by reference.

Steel processing installation 1 is very similar to conventional installations for processing steel strips 2. Section 10 is a conventional arrangement for slow cooling the strip 2 to below 760° C. Generally, the steel strip still has a temperature greater than 650° C. Section 12 contains a gas-jet coolers. Four are used as an example in FIG. 1. However, a greater or lesser number can be used within the concept of the present invention. This section normally cools strip 2 to a temperature below 550° C. However, a variation of this temperature is permitted within the concept of the present invention.

The next portion of the system is novel in that it is constituted by a chute 14, approximately 8 meters long. The chute contains strip 2 as it moves from jet cooling section 12 to the zinc pot galvanizing bath 16. Zinc pot bath 16 effects very rapid cooling, an entirely novel aspect for this type of system. The temperature is rapidly lowered approximately 110° C. in the zinc galvanizing bath. Afterwards, strip 2 is conveyed out of the bath and into section 18, occupied by air coolers.

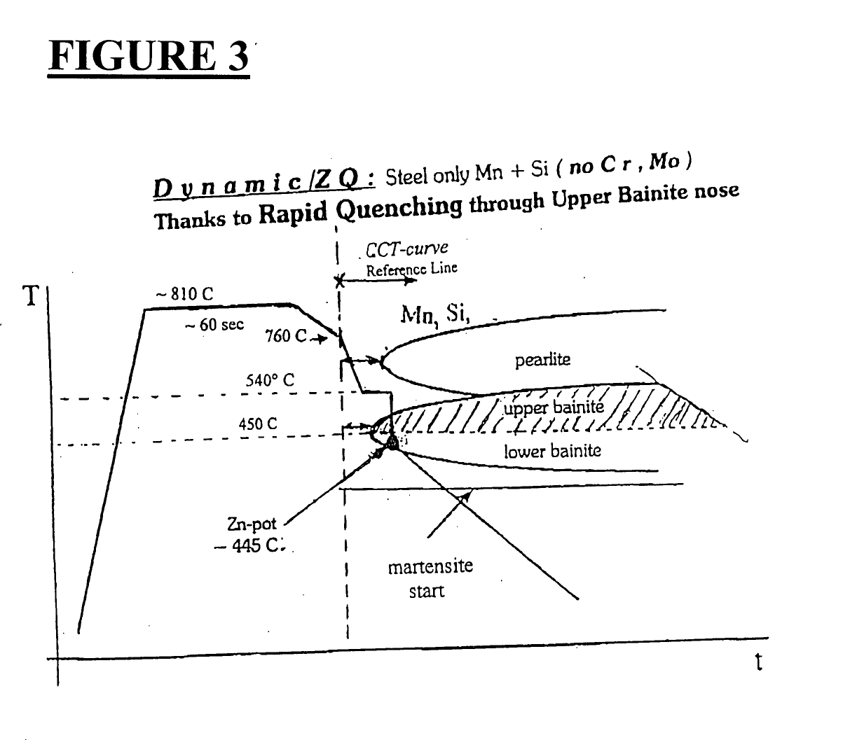

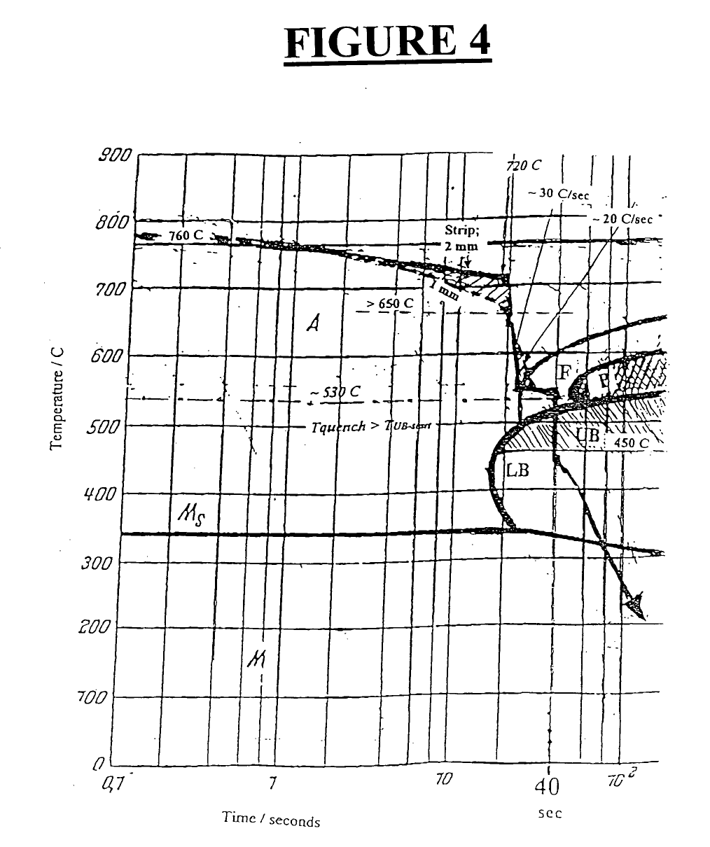

The use of this or similar galvanizing processor 16 permits the particular quick quenching depicted in the graph of FIGS. 3 and 4 to produce the favorable, efficient processing and superior product of the present invention. The air-cooling portion 18, which is necessary to any steel strip process, can be that described in U.S. Pat. No. 4,361,448 (to the same inventor), incorporated herein by reference.

For exemplary purposes, the process is described for steel strips 1 mm and 2 mm in thickness. These are contrasted in FIG. 4. The clearest distinction between the process for a 1 mm strip and a two millimeter strip is the cooling time involved. The 1 mm strip cools at a much faster rate then the 2 mm strip due to the difference in mass. Nonetheless, the operation of the present invention is capable of sufficiently quick cooling to limit the formation of upper bainite, even in 2 mm thick strips.

It should be noted that the curve alters in the lower bainite region, indicative of a longer time spent in the cooling cycle once the formation of lower bainite begins and upper bainite ceases. This is true for thicknesses of both 1 mm and 2 mm. While there are some differences between the inventive processes applied to both thicknesses, these are generally trivial in nature. This is in marked contrast to the conventional art in which substantial differences are required between the processing of a 1 mm strip and a 2 mm strip. It should be understood that other thicknesses can be handled by the process of the present invention, and that other shapes besides strips can be subjected to the operation of the present inventive process to result in a superior product.

Slow cooling by air-cooling radiant tubes in section 18 is necessary for the overall process of the present invention as it is in any steel processing system. However, other slow-cooling methods can also be used within the overall concept of the present invention. It should also be understood that slow-cooling methods can vary in accordance with the particular type of product being processed.

It should be understood that the present invention is also constituted by both a system and a final product,as well as a process. If the final product can be made by a process not disclosed herein, it still falls within the general concept of the present invention. Likewise, the rapid quenching to create a somewhat different product also can be used as part of the present invention. This system of FIG. 1 can also be used to produce a different final product, using the benefits of quick cooling.

The inventive process is carried out using the installation depicted in FIG. 1. The steel strip 2 is annealed between 800° C. and 820° C., as described in various publications and Appendix II, previously incorporated by reference. Thereafter, the strip is slowly cooled in cooling section 10 to a temperature between 760° C. and 650° C., in order to produce the maximum volume percentage of epitaxial ferrite in the dual-phase steel structure. It should be understood that these values are only for exemplary purposes, and the present invention is not limited thereby.

When dealing with a 1 mm strip the processing line speed is 90 meters per minute. The strip is gas-jet cooled from a temperature higher than 650° C. to a temperature below 550° C., with a cooling rate of approximately 100° C. per second. During this part of the process, the atmosphere gas is approximately 10% hydrogen in content.

Then the strip is slowly cooled in a chute 14 approximately eight meters long, to a value somewhat below 540° C. This phase of the process takes approximately five seconds.

A rapid quenching of the steel strip takes place in the zinc bath 16. The temperature is lowered from approximately 540° C. to below 450° C., using the method described in U.S. Pat. No. 5,958,518, previously incorporated by reference. Other rapid quenching systems and techniques can also be used within the concept of the present invention. Since the cooling rate is approximately 500° C. per second, this phase of the quenching process takes less than one second as depicted in FIGS. 3 and 4. In this example, the temperature of the zinc bath 16 is approximately 445° C. and the aluminum content of the bath is less than 0.17%.

After the quenching cycle, typical processes occur. These are the normal aftermath of any hot-dip galvanizing process. These include gas-wiping and air-cooling after the solidification of the zinc coating. Preferably this is done using the technique described in U.S. Pat. No. 4,361,448, previously incorporated by reference.

For the example of the 2 mm strip (depicted in FIG. 4 along with the example of a 1 mm strip), the line speed is only 45 meters per minute. The strip is gas-jet cooled from a temperature of approximately 720° C. to one below 550° C., with a cooling rate of 30° C. per second. If needed a 30% hydrogen gas injection can be used to facilitate more rapid cooling.

The strip 2 is slowly cooled further in a chute 14 approximately eight meters in length. The temperature drops to 540° C. or below in approximately ten seconds.

Then, the rapid quenching takes place in the zinc bath 16. Here the temperature drops from 540° C. to below 450° C. The temperature of the zinc bath is approximately 440° C., and the aluminum content of the bath is less than 0.17%. The temperature fall is approximately 200° C. per second so that the quenching phase in the zinc bath takes less than one second. This is a remarkably short time for processing a 2 mm strip as compared to the conventional art. Afterwards, the zinc strip is processed in the same way as the 1 mm strip, described supra.

Overall, the present invention will provide cooling of both 1 mm and 2 mm thick strips from a temperature of 760° C. to below 450° C. in less than forty seconds. It is also possible to reduce this time to less than 25 seconds for steel strips having a thickness of both 1 mm and 2 mm.

To provide for the rapid cooling necessary in the quenching phase, the zinc bath temperature will be approximately 440° C. for 2 mm strips, and 445° C. for 1 mm strips. Fortunately, the system described in U.S. Pat. No. 5,958,518 facilitates this temperature control so that there is easy conversion from 1 mm strips to 2 mm strips.

The quenching of the strip 2 is carried out as quickly as possible from a temperature of over 520° C. to one below 450° C. It should be noted that 520° C. is approximately the temperature at which upper bainite begins to form from austenite. Below 450° C., the austenite will be transformed to lower bainite and to martensite, both of which are needed to obtain proper dual-phase structure. On the other hand, upper bainite is very similar to pearlite, and both are detrimental, and to be avoided in creating a dual-phase steel.

A cooling time of less than 40 seconds from 760° C. to below 450° C. will be adequate to avoid the formation of pearlite and upper bainite, and to produce highly formable, dual-phase structure from the composition with plain Mn—Si alloying, where Mn is less than 1.65% and Si is less than 0.5%.

The benefits of using Si as an alloying agent have already been discussed. However, certain surface-critical products may be deteriorated by Si alloying, and thus, should be produced without Si. To compensate for the benefit of Si, the Mn content should be increased, but should remain less than 1.75%. The ability to adjust the balance between Si and Mn is one of the benefits of the present invention.

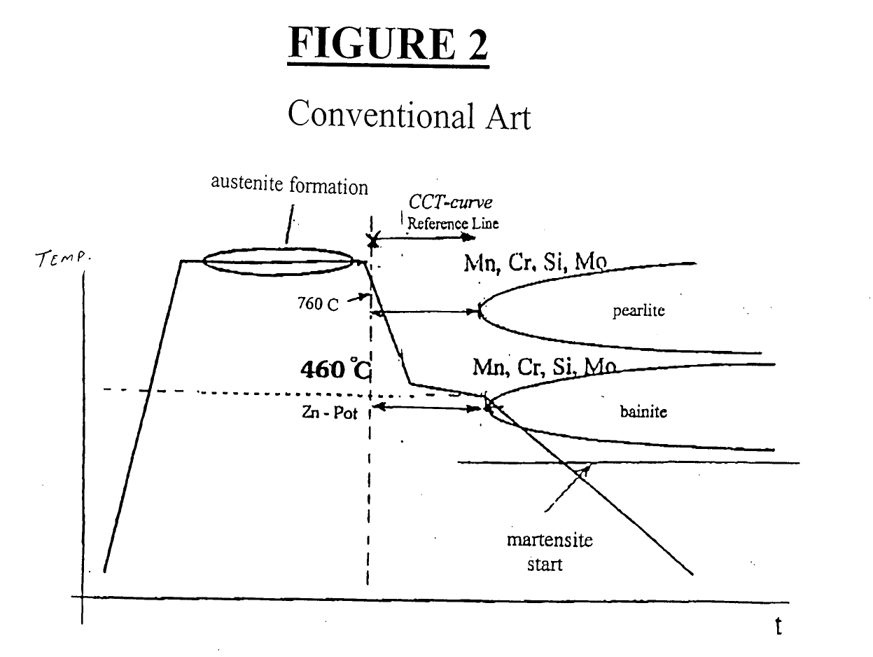

In conventional systems as depicted in FIG. 2, the temperature of the zinc bath is generally 460° C. Above 450° austenite will be transformed into upper bainite, a very undesirable circumstance. To avoid this, conventional systems use a substantial amount of alloying, increasing the hardenability to make the austenite stable. Also, a longer annealing time of one to three minutes will increase hardenability of austenite.

In contrast, the fast cooling of the present invention avoids both pearlite and upper bainite while saving a great deal of processing costs, thereby making the overall process much less expensive. Further, expenses are decreased by eliminating extremely expensive alloying agents such as Mo and Cr. Also, the use of standard Si and/or Mn alloying agents in the steel, allows a relatively inexpensive and widely available grade to be purchased for the process.

For conventional (non-dual-phase) steels reduced formability is one of the consequences in manufacturing steels with higher strength levels. As indicated in Appendix II and other publications, the problem is addressed by dual-phase steel. The present invention improves upon this, providing a dual-phase steel that has a high-strength, low-yield ratio (YS/TS) and high ductility.

It is well known that the steel metallurgy of dual phase steels having high alloying will result in reduced n-values. The n-values of highly alloyed dual-phase steel are between 0.17 and 0.19. (where the tensile strength is greater than 600 Mpa). Because the present invention allows for low alloying of the dual-phase steel, n-values of between 0.22 and 0.24 will result. This is one of the benefits of being able to use silicon alloying in the process.

In determining the hardenability of alloying elements for steel chemistry using the present invention, an Mn equivalent is used, and designated Mn-eq. The formula for this is Mn-eq=% Mn+0.26(% Si). For example when there is a steel chemistry of 1.65% Mn and 0.4% Si then the hardenability factor Mn-eq=1.75%. If, for example, all of the Si is eliminated, then additional Mn will have to be used to replace it. To maintain the Mn-eq at 1.75%, an additional 0.1% Mn will have to be used to compensate for the 0.4% Si which has been eliminated.

The n-value is from 1%-10% greater than conventional dual-phase steels. Because of the high strength and ductility, the inventive product manufactured by the inventive process avoids local strength variations, thereby promoting more uniform ductility of the final steel product.

One aspect of the inventive installation of FIG. 1 is improved economy in the operation of the installation. In particular, the length of the connecting chute 14 between the gas-jet coolers 12 and the zinc pot 16 can be made as long as 10 meters and as short as 7 meters. This enhances the adaptability of the present invention to existing systems.

Another key advantage of the present invention is the low percentage of aluminum in the galvanized coating, less than 0.35% with a 70/70 g/m² coating weight. A key advantage in having a low percentage of aluminum in the coating is that the electrode life of a spot welding apparatus used on the subject steel is greatly increased since high levels of aluminum have proven to be detrimental to the lifetime of spot welding electrodes. For example, tests on 0.8 mm hot-dip galvanized steel found that for an aluminum content of 0.26%, electrode life was good for approximately 1500 welds. With the same kind of steel, and 0.45% aluminum, the electrode life was only extended for approximately 500 welds. This is an economy provided by combining the fast quenching apparatus such as that of U.S. Pat. No. 5,958,518 with a process for making dual-phase steel.

While a number of preferred embodiments have been described by way of example, the present invention is not limited thereto. Rather, the present invention should be interpreted to cover any and all variation, permutations, adaptations, and embodiments that might occur to someone skilled in this technology once being taught the present invention. Accordingly, the present invention should be construed to be limited only by the following claims.

1. A dual-phase, high-strength steel comprising ferrite, martensite and retained austenite, no pearlite and minimal upper bainite, with a low aluminum content galvanized coating.

2. The alloy of claim 1, wherein said alloy is formed in a strip of relatively uniform ductility.

3. The alloy of claim 2, wherein said alloying elements of steel chemistry is selected only from a group consisting of Mn and Si.

4. The alloy of claim 3, wherein the total percentage of Mn is less than substantially 1.69%, and the amount of Si is less than substantially 0.5%.

5. The alloy of claim 4, wherein said strip is between substantially 1 millimeter and 2 millimeters in thickness.

6. The alloy of claim 5, wherein said strips have a galvanized coating of less then 0.35% aluminum with a coating weight of 70/70 g/m2 per side.

7. The alloy of claim 6, wherein said zinc-aluminum coating is 70 grams per m² on one side.

8. The alloy of claim 7, wherein Fe—Zn alloy phases are minimized on said galvanized coating even using a bath having aluminum content less than 0.17%, to achieve a substantially dross-free coating.

9. A process of producing dual-phase steel alloy having substantially uniform strength properties, comprising:
(a) conducting rapid cooling operations to limit upper bainite formation and avoid pearlite formation

10. The process of claim 9, wherein step (a) comprises a rapid quenching substep of lowering said steel alloy from 540° C. to 450° C. in one second.

11. The process of claim 10, wherein said substep of lowering said temperature of said steel alloy is conducted in a galvanizing bath.

12. The process of claim 11, wherein said galvanizing bath minimizes Fe—Zn alloy phases in a coating on a surface of said steel alloy.

13. The process of claim 12, wherein prior to using said galvanizing bath, subjecting said alloy to gas jet cooling.

14. The process of claim 13, wherein subsequent to using said galvanizing bath, applying air cooling after the bath to said steel alloy.

15. The process of claim 10, wherein said alloy is in the form of a strip.

16. The process of claim 15, wherein said strip is processed using the same equipment and chemistry for all thicknesses from substantially 1 millimeter to substantially 2 millimeters.

17. The process of claim 10, wherein alloy materials are selected only form a group consisting of Mn and Si.

18. The process of claim 17, comprising the step of balancing the content of Mn and Si in said alloy.

19. The process of claim 18, wherein said amount of Mn is less than substantially 1.65%, and the amount of Si is less than substantially 0.5%.

20. The process of claim 12, wherein aluminum in said galvanized coating from said galvanizing bath is less than substantially 0.35% and coating weight 70/70 g/m2.

21. A system for producing dual-phase steel, said system comprising: rapid quenching means for avoiding pearlite formation and minimizing upper bainite formation.

22. The system of claim 21, wherein said quenching means comprise first means for lowering temperature of said dual-phase steel from 760° C. to 450° C. in 40 seconds.

23. The system of claim 22, wherein said first means for lowering temperature further comprise second means for lowering temperature of said dual-phase steel from higher than 520° C. to 450° C. in one second.

24. The system of claim 23, wherein said second means for lowering temperature comprise a zinc galvanizing bath and a eight meter chute leading to said zinc galvanizing bath.

25. The system of claim 24, further comprising means for alloying said dual-phase steel, where alloying materials are limited to a group selected from Mn and Si.

26. The system of claim 22, wherein said first means for lowering temperature further comprise gas jet coolers, and after the bath air coolers.

27. The system of claim 25, wherein said means for alloying comprise means for balancing amounts of Si and Mn.

28. The system of claim 24, wherein said zinc galvanizing bath comprise means for minimizing aluminum in a zinc coating on said dual-phase steel from said zinc galvanizing bath.

29. The system of claim 28, wherein said zinc galvanizing bath comprise means for minimizing Fe—Zn alloy phases on said zinc coating, to effect a substantially dross-free galvanized coating.
